(19) United States
(12) Patent Application Publication
(10) Pub. No.: US 2009/0146695 A1
(43) Pub. Date: Jun. 11, 2009

(54) HYBRID IC FOR ULTRASOUND BEAMFORMER PROBE

(75) Inventors: Scott Schweizer, Snohomish, WA (US); Shon Schmidt, Seattle, WA (US); Manfred Bartz, Snohomish, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,813

(22) PCT Filed: Nov. 17, 2005
(86) PCT No.: PCT/IB2005/053803

§ 371 Date: May 21, 2007

Related U.S. Application Data
(60) Provisional application No. 60/630,090, filed on Nov. 22, 2004.

(51) Int. Cl. B06B 1/02

(52) U.S. Cl. 327/108

(57) ABSTRACT

A hybrid integrated circuit package for a microbeamformer in an ultrasound probe includes a substrate, a driver circuit for generating transmit pulses to be transmitted to the transducer elements of the probe for producing a transmit beam, and a beamformer circuit including time delay circuits and a summation circuit, the time delay circuits being operatively arranged for receiving a plurality of reflected pulses from the transducer elements and delaying the reflected pulses and the summation circuit operatively arranged summing groups of the delayed reflected pulses for producing beamformed signals. The driver circuit is part of a high voltage integrated circuit device including said driver circuit. At least a portion of the beamformer circuit is part of a low voltage integrated circuit device, wherein the high voltage integrated circuit and the low voltage integrated circuit are mounted on the substrate.

The present invention relates to a hybrid integrated circuit (IC) for an ultrasound beamformer probe providing both the high-voltage requirements of the transducer element interface and the high density functionality requirements of the control and beamforming functions.

Medical ultrasound imaging systems are used for non-invasively viewing internal structures of the human body in real time. The ultrasound imaging systems include an array of transducers for transmitting and receiving ultrasonic pulses. Each transducer is a piezo-electric element. A transmit beamformer circuit applies electric pulses to each transducer in the array of transducers in a specific timing sequence to product a transmit beam. The transmit beam is reflected by tissue structures having disparate acoustic characteristics. The reflected beam is converted by the receive transducers into electric pulses which are translated into image signals which may be represented by a display. Each transducer may operate as both transmit and receive transducer.

To achieve high resolution, the transducer array is made to include several hundred to several thousand transducer elements. The transducers are connected to microbeamformer electronics which transform the large number of signals from the transducers into a number of signals which can be managed by a further beamformer in the ultrasound processor station. The microbeamformer electronics are required to be arranged in the probe with the transducers because it is difficult to transmit all of the signals from the transducers to the ultrasound processing station by cable.

Circuits in the probe are required to provide enough voltage and power for operating the driver for the transmit beam and must at the same limit heat production at the probe. Probes typically require 60-200Vₚ₋ₚ, with newer probes being at the lower end of the range. The driver for pulsing the elements and switches to connect and disconnect the receiver from the transmit pulses are required to produce these voltages. However, the control and beamforming functions require a high density of integration for handling the large number of signals from the transducers. IC devices that offer high voltage are physically large, consume more energy and thereby produce more heat. However, IC devices that offer high density limit the working voltage.

It is an object of the present invention to provide a hybrid IC which meets both the high voltage and high density requirements for a micro-beamformer ultrasound probe.

The object of the present invention is met by a hybrid integrated circuit package for a microbeamformer in an ultrasound probe, the ultrasound probe having an array of transducer elements for transmitting and receiving pulses. The circuit package includes a substrate, a high voltage integrated circuit device including a driver for generating a transmit pulse to be transmitted to the transducer elements for producing a transmit beam, and a low voltage integrated circuit device including time delay circuits for receiving reflected pulses from the transducer elements and delaying the reflected pulses and a summation circuit summing groups of the delayed reflected pulses for producing beamformed signals. The high voltage integrated circuit device may also include a switch for isolating the transmit pulses from the reflected pulses and an amplifier for implementing a receiver gain.

The high voltage integrated circuit may be CMOS or BiCMOS and the low voltage integrated circuit comprises complementary metal oxide semiconductors (CMOSs).

In some cases, the array of transducer elements may be connected directly to said substrate.

The substrate may be rigid or flexible. Furthermore, the substrate may comprise a rigid component connected to a flex material.

The high voltage integrated circuit device and the low voltage integrated circuit device may be connected to the substrate using a ball grid array.

Furthermore, the high voltage integrated circuit device, the low voltage integrated circuit device, and the substrate may be connected in a stacked arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In the drawings, wherein like reference characters denote similar elements throughout the several views:

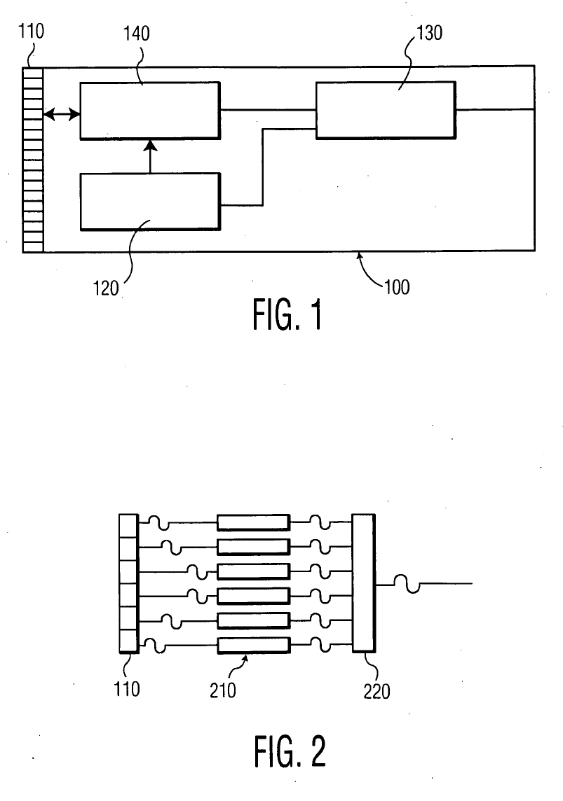

FIG. 1 is a block diagram of an ultrasound probe according to the present invention;

FIG. 2 is a simplified schematic diagram illustrating the beamformer concept;

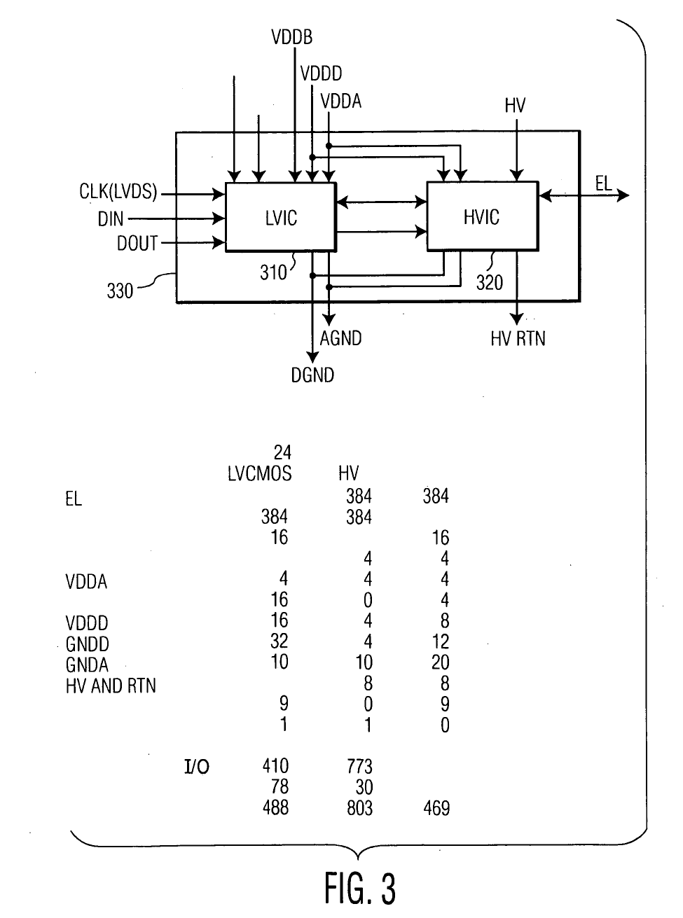

FIG. 3 is a schematic diagram of a hybrid IC according to the present invention;

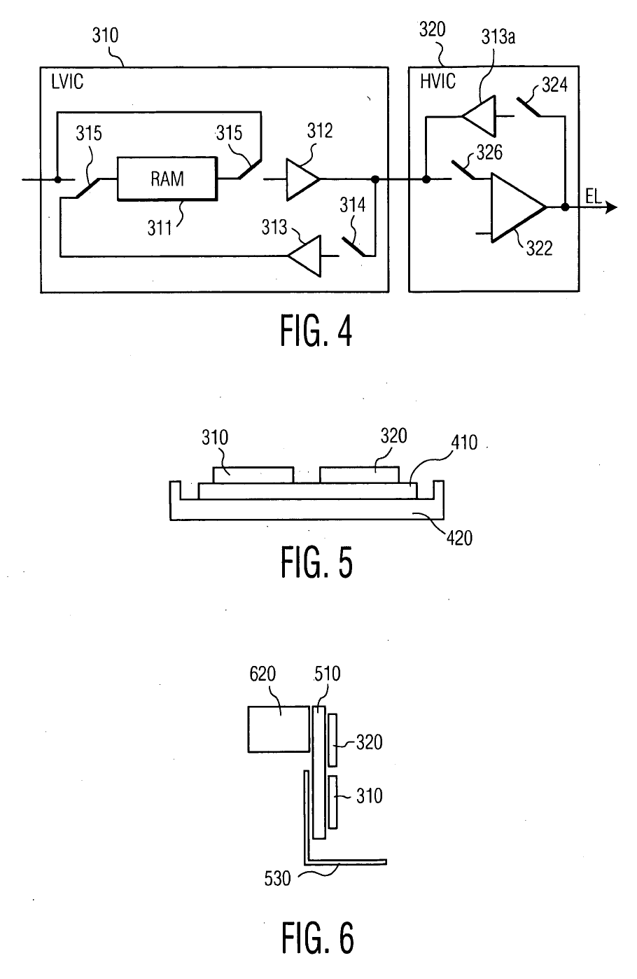

FIG. 4 is a schematic diagram showing one channel of the hybrid IC of FIG. 3;

FIG. 5 is a sectional view of a multi package module (MPM) according to the present invention;

FIG. 6 is a cross sectional view of another MPM of the present invention;

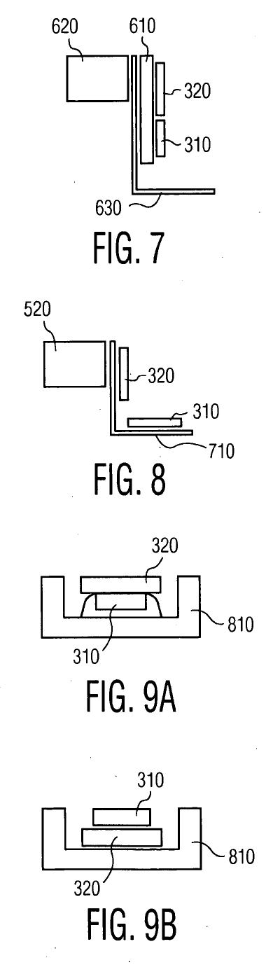

FIG. 7 is a cross sectional view of a further MPM of the present invention;

FIG. 8 is a cross sectional view of yet another MPM according to the present invention; and

FIGS. 9a and 9b are cross sectional views of MPMs according to the present invention.

FIG. 1 is a block diagram of an ultrasound probe 100 including transducers 110. A transmit circuit 120 is arranged in the probe 100 for generating electric pulses which are applied to the transducers 110 for generating a transmission beam in a subject. The transmit circuit 120 generates the electric pulses in response to signals received from a beamformer circuit 130 which applies time delays for focusing the transmit pulse, as required. The beamformer circuit 130 is arranged for receiving reflected pulses from the transducers 110. The beamformer circuit 130 may also apply time delays and/or a gain control to set a power level of the reflected beam. A transmit/receive (T/R) switch 120 is connected to the transducers 110, the transmit circuit 120, and the beamformer circuit 130 for isolating the transmit pulses from the reflected pulses. In the preferred embodiment, the ultrasound probe 100 is a micro beamformer ultrasound probe having thousands of transducers for enabling three-dimensional imaging. Alternatively, the ultrasound probe may comprise 1×D type probes which have an expanding elevation aperture to provide enhanced 2D images. These 1×D probes are also referred to as 1.125D, 1.25D . . . 1.75D probes, where the number is indicative of the type of focus method used.

FIG. 2 is a simplified schematic diagram illustrating the beamformer concept for processing reflected signals. The beamformer 130 include time delay circuits 210 and signal summation circuit 220. As mentioned above, the time delay circuits 210 may be used to focus the transmit pulses. After the transmit pulse/pulses are applied, each transducer 110 receives a reflected pulse and generates a signal based on the reflected pulse. The time delay circuits 210 may apply a time delay to the reflected pulse signals and the reflected pulse signals are then summed in the summation circuit 220 to produce a formed beam. FIG. 2 shows six transducers for forming one formed beam for simplicity. The probe 100 may have thousands of transducers and the beamformer 130 may reduce those thousands of signals from the transducers to hundreds of signals which are sent to a ultrasound processor for further beamforming. This type of probe is disclosed in U.S. Pat. Nos. 6,491,634 and 6,013,032, the entire contents of which are expressly incorporated herein by reference.

FIG. 3 is a schematic diagram showing a low voltage integrated circuit (LVIC) 310 and a high voltage integrated circuit (HVIC) 320 and a list of the number of pins for various signals which are described below. Microbeamformer probes having a large number of transducers require a high density integrated circuit to manage the thousands of transducer signals. At the same time, high voltage is required for the drivers for generating the transmit pulses to the transducers. The HVICs which do provide the required voltage level typically do not have the density required for the microbeamformers. In addition, these HVICs use a lot of energy which creates heat. The creation of heat is detrimental to ultrasound probes because ultrasound probes must operate within guidelines which limit the amount of heat which can be generated. According to the invention, a hybrid integrated circuit package includes the LVIC 310 and the HVIC 320 to provide both the high voltage necessary for creating transmission pulses and the density required for managing the reflected pulses from the transducers. The HVIC 320 provides the transmit circuit 120 and also includes the switch 140. The LVIC 310 includes the beamformer 130. The signal EL represents the connection to the transducer elements. The Analog signals are the signals from the transducers that are transmitted to the LVIC through the T/R switch. HV and RTN provide high voltage signals to the HVIC for producing the pulses. The SUM signal is the output of the beamformer which is sent to the external ultrasound processor. VDDA, VCORE, VDDD are voltage supply connections. GNDD and GNDA are ground connections. CTRL lines are the control lines which control the delay and biasing functions for the transmit pulses and reflected pulses.

In the preferred embodiment, the circuit shown in FIG. 1 is an analog circuit. At present, the limitations of the technology prevent the inclusion of conversion to digital signals within the probe. However, it is possible that in the future, the beamformer circuit 130 may also comprise a digital circuit which includes A/D converters, wherein the signals received from the reflected pulses are converted from analog to digital signal before they are time delayed and summed.

In one embodiment, the LVIC 310 is made using CMOS technology and the HVIC 320 is manufactured using bipolar or field effect transistor technology. While CMOS technology is currently preferred, the LVIC 310 may alternatively be manufactured using Field Programmable Gate Arrays (FPGAs).

FIG. 4 shows a single channel of the LVIC 310 and HVIC 320 for transmitting and receiving to one transducer element. The LVIC 310 includes a RAM 311 comprising a delay line, a driver 312 and a preamp 313. The HVIC 320 includes a modified Operational Transconductance Amplifier (OTA) 322 and may also include an amplifier 313a for amplifying the reflected pulse. The modifications to the OTA for the present application include a bias adjustment for allowing a user to trade power consumption for harmonic distortion, a disable function to reduce power in the receive mode, a fixed gain low noise amplifier, and a connection to the transmit/receive switch. Although the preferred embodiment uses an OTA 322, other types of amplifiers may also be used.

In the transmit mode, the delay line 311 is reversed via switches 315 and the capacitors of the delay line 311 are pre-charged. The HV amplifier 322 is connected to the RAM by switch 326 and the HV transmit receive switch 324 is open, blocking the high voltage from being applied to the LVIC 310. In this mode, a pulse from the HV amplifier 322 is applied to the load, i.e., the transducer element EL.

In the receive mode, the delay line 311 is arranged to receive an input. Switch 326 is open to disconnect the HV amplifier 322 from the RAM 311. The HV transmit/receive switch 324 is closed and the signal generated at the transducer element in response to the pulse from the HV amplifier 322 is allowed to pass to the delay line 311 of the LVIC 310. The delayed signal is then sent to a summer for further processing.

The LVIC 310 and the HVIC 320 may be arranged in any hybrid IC configurations that are now known or will be subsequently known in the art. By non-limiting example, FIGS. 5-9b show various exemplary configurations which may be used. However, these examples in no way limit the various technologies which may be used to create hybrid IC packages which include two or more interconnected ICs made using different process technologies. FIG. 5 shows the LVIC 310 and HVIC 320 arranged on a high density substrate 410 for interconnection. Such a configuration is referred to as a Multi Package Module (MPM). The substrate medium preferably allows both flip chip and wire bond connections. However, the connections may be exclusively flip chip or wire bond connections. As shown in FIG. 5, the substrate 410 may be put into a standard ball grid array 420. Such chip on substrate configurations are used, for example, by Amkor Technology, Inc. Chandler Ariz.

FIG. 6 shows another embodiment in which the LVIC 310 and the HVIC 320 are connected to substrate 510. In addition, a sensor 520 including the transducers 110 is also connected to the substrate 510. FIG. 6 also shows that a flexible connector 530 may connected to the substrate for carrying the signals from the probe to the ultrasound processor. FIG. 7 shows yet another embodiment in which a sensor 620 is connected directly to a flexible connector 630 and a substrate 610 is connected to the flexible sensor 630. In the FIG. 7 embodiment, the substrate is connected to the LVIC 310 and the HVIC 320. In a further configuration shown in FIG. 8, the LVIC 310, the HVIC 320, and the sensor 520 are each connected to a flexible substrate 710. In this embodiment, the connection may be made using a micro ball grid array. Flexible connection materials are made, for example, by Dyconex AG, Bassersdorf, Switzerland and Tessera, Inc., San Jose, Calif.

FIGS. 9a and 9b show that a stacked die concept may also be used to assemble the hybrid IC. In the embodiments shown, the LVIC 310 and HVIC 320 are arranged in a micro ball grid array substrate 810. The stacking of the LVIC 310 and HVIC 320 may be accomplished using neo-stacking technologies by Irving Sensors, Inc., Costa Mesa, Calif., in which the interconnection is made by side plating. Alternatively, the interconnection may occur at the package level using bond wires as by ChipPAK, Inc., Korea.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A hybrid integrated circuit package for a microbeamformer in an ultrasound probe, the ultrasound probe having an array of transducer elements for transmitting and receiving pulses, said circuit package comprising:
a substrate;
a driver circuit for generating focused transmit pulses to be transmitted to the transducer elements for producing a transmit beam;
a beamformer circuit including time delay circuits and a summation circuit, the time delay circuits being operatively arranged for receiving a plurality of reflected pulses from the transducer elements and delaying the reflected pulses, and the summation circuit operatively arranged for summing groups of the delayed reflected pulses for producing beamformed signals;
a high voltage integrated circuit device including said driver circuit; and
a low voltage integrated circuit device including at least a portion of said beamformer circuit, said high voltage integrated circuit and said low voltage integrated circuit being mounted on said substrate.

2. The circuit package of claim 1, wherein said high voltage integrated circuit device includes a switch for isolating the transmit pulses from the reflected pulses.

3. The circuit package of claim 1, wherein said low voltage integrated circuit device includes the entire beamformer circuit.

4. The circuit package of claim 1, wherein said high voltage integrated circuit comprises bipolar transistors (BPTs) or Field Effect Transistors (FETs).

5. The circuit package of claim 1, wherein said low voltage integrated circuit comprises complementary metal oxide semiconductors (CMOSs).

6. The circuit package of claim 1, further comprising the array of transducer elements, wherein said array is connected directly to said substrate.

7. The circuit package of claim 1, wherein said substrate is rigid, said package further comprising a flex material connected to said substrate.

8. The circuit package of claim 7, further comprising the array of transducer elements, wherein said array is connected to said flex material.

9. The package of claim 1, wherein said substrate comprises a flex material.

10. The circuit package of claim 9, wherein said high voltage integrated circuit device and said low voltage integrated circuit device are connected to said flex material using a ball grid array.

11. The circuit package of claim 1, wherein said high voltage integrated circuit device and said low voltage integrated circuit device are each connected to said substrate using a ball grid array.

12. The circuit package of claim 1, wherein said high voltage integrated circuit device, said low voltage integrated circuit device, and said substrate are connected in a stacked arrangement.
